(19) United States
(12) Patent Application Publication
(10) Pub. No.: US 2011/0264595 A1
(43) Pub. Date: Oct. 27, 2011

(54) VEHICLE VALUE ANALYSIS

(76) Inventors: Jeremy Anspach, Charleston, SC (US); Frank Adam Veltri, Charleston, SC (US)

(21) Appl. No.: 13/082,270

(22) Filed: Apr. 7, 2011

Related U.S. Application Data
(60) Provisional application No. 61/342,040, filed on Apr. 8, 2010.

(51) Int. Cl. G06Q 99/00

(52) U.S. Cl. 705/306

(57) ABSTRACT

A method of analyzing a value of a vehicle, the method comprising: (a) receiving a request for information concerning a particular vehicle for sale; (b) receiving vehicle data concerning the particular vehicle and a plurality similar vehicles for sale from at least one source; (c) comparing the vehicle data to identify a subset comprising a plurality of comparable vehicles that are comparable to the particular vehicle and that are for sale; (d) comparing the vehicle data of the particular vehicle to the vehicle data of at least one of the plurality of comparable vehicles to asses a relative value of the particular vehicle; and, (e) generating a report that conveys the relative value of the particular vehicle.

### CROSS REFERENCE TO RELATED APPLICATIONS

This application claims the benefit of U.S. Provisional Patent Application Ser. No. 61/342,040, filed Apr. 8, 2010, entitled “VEHICLE VALUE ANALYSIS,” the disclosure of which is incorporated herein by reference.

### RELATED ART

1. Field of the Invention

The present disclosure is directed to methods, systems, and devices related to analyzing a value of a vehicle. Specifically, the disclosed methods, systems, and devices relate to generating one or more reports comprising vehicle data and comparison data related to pricing information of a particular vehicle in relation to similar vehicles within a geographic region.

2. Brief Discussion of Related Art

Potential vehicle consumers may desire information about whether a given vehicle is a good value based on similar vehicles for sale. With value indicator information related to similar vehicles, consumers may have confidence that a given vehicle for sale is or is not a good value. Armed with this information, it is up to the consumer to ultimately determine whether, and to what extent, those value indicators are relevant to them. Therefore, consumers may desire a graphical interface and/or report to inform them on value indicators of a vehicle and whether the price is competitive with other similar vehicles for sale that may be narrowed to a particular geographic region.

### INTRODUCTION TO THE INVENTION

The present invention is directed to methods, systems, and devices related to analyzing a value of a vehicle. Specifically, the disclosed methods, systems, and devices relate to generating one or more reports comprising vehicle data and comparison data related to pricing information of a particular vehicle in relation to similar vehicles within a geographic region.

It is a first aspect of the present invention to provide a method of analyzing a value of a vehicle, the method comprising: (a) receiving a request for information concerning a particular vehicle for sale; (b) receiving vehicle data concerning the particular vehicle and a plurality similar vehicles for sale from at least one source; (c) comparing the vehicle data to identify a subset comprising a plurality of comparable vehicles that are comparable to the particular vehicle and that are for sale; (d) comparing the vehicle data of the particular vehicle to the vehicle data of at least one of the plurality of comparable vehicles to asses a relative value of the particular vehicle; and, (e) generating a report that conveys the relative value of the particular vehicle.

In a more detailed embodiment of the first aspect, receiving vehicle data from at least one source further comprises formatting the vehicle data based utilizing a standardized rule set. In yet another more detailed embodiment, the vehicle data comprises at least three of a make, a model, a year, a body style, a trim, an interior color, an exterior color, a mileage, a certified status, a used status, a new status, a transmission type, an engine, a fuel economy rating, a warranty, a vehicle identification number, a stock identifier, a dealer, a location, and a price. In a further detailed embodiment, the vehicle data comprises at least one of a number of accidents reported, a number of previous owners, and an identification of previous owners. In still a further detailed embodiment, the request for information comprises at least one of a year, a make, a model, a mileage, a location, and a zip code. In a more detailed embodiment, generating the report further comprises generating a compilation video by operably coupling at least two video snippets, each video snippet being associated with a specific one of the vehicle data associated with the particular vehicle and, generating the report further comprises at least one of linking and attaching the compilation video to the report. In a more detailed embodiment, the predetermined geographical region comprises a specific mile range.

It is a second aspect of the present invention to provide a method of analyzing a value of a vehicle, the method comprising: (a) compiling a comparative data set attributable to a group of vehicles for sale by selecting vehicles having at least one attribute in common with a target vehicle; (b) analyzing an advertised price of at least one vehicle of the group of vehicles with respect to an advertised price of the target vehicle; and, (c) generating a report qualitatively assessing a relative value of the target vehicle with respect to the at least one vehicle of the group of vehicles.

In a more detailed embodiment of the second aspect, the act of compiling the comparative data set includes compiling individual data sets for each of the group of vehicles, the comparative data set comprises the individual data sets and, the attribute includes at lest one of a make, a model, a year, a body style, a trim, an interior color, an exterior color, a mileage, a certified status, a used status, a new status, a transmission type, an engine, a fuel economy rating, a warranty, a vehicle identification number, a stock identifier, a dealer, a location, and a price. In yet another more detailed embodiment, the embodiment further includes the act of calculating a difference in at least one of mileage and advertised price of the at least one vehicle of the group of vehicles and the target vehicle, wherein the act of generating the report includes quantitatively assessing the difference in at least one of mileage and advertised price of the at least one vehicle of the group of vehicles and the target vehicle. In a further detailed embodiment, the act of generating the report qualitatively assessing the relative value of the target vehicle with respect to the at least one vehicle of the group of vehicles includes displaying at least one standardized value indicator. In still a further detailed embodiment, the embodiment further includes compiling a comparative data set attributable to a group of sold vehicles by selecting vehicles having at least one attribute in common with the target vehicle and, analyzing a sale price of at least one vehicle of the group of sold vehicles with respect to the advertised price of the target vehicle, where generating the report includes qualitatively assessing the relative value of the target vehicle with respect to the at least one vehicle of the group of sold vehicles.

It is a third aspect of the present invention to provide a method of analyzing a value of a vehicle, the method comprising: (a) compiling a comparative data set attributable to a group of vehicles for sale by selecting vehicles having at least one attribute in common with a target vehicle; (b) analyzing an advertised price of at least one vehicle of the group of vehicles with respect to an advertised price of the target vehicle; and, (c) generating a report graphically depicting a quantitative comparison between the advertised price of the target vehicle and an average advertised price of the at least one vehicle of the group of vehicles.

In a more detailed embodiment of the third aspect, the act of compiling the comparative data set includes compiling individual data sets for each of the group of vehicles, the comparative data set comprises the individual data sets and, the attribute includes at lest one of a make, a model, a year, a body style, a trim, an interior color, an exterior color, a mileage, a certified status, a used status, a new status, a transmission type, an engine, a fuel economy rating, a warranty, a vehicle identification number, a stock identifier, a dealer, a location, and a price. In yet another more detailed embodiment, the embodiment further includes the act of calculating a difference in at least one of mileage and advertised price of the at least one vehicle of the group of vehicles and the target vehicle, wherein the act of generating the report includes quantitatively assessing the difference in at least one of mileage and advertised price of the at least one vehicle of the group of vehicles and the target vehicle. In a further detailed embodiment, the act of generating the report includes qualitatively assessing a relative value of the target vehicle with respect to the at least one vehicle of the group of vehicles using standardized value indicators taken from the group of advertised price, mileage, age, and location. In still a further detailed embodiment, the embodiment further includes compiling a comparative data set attributable to a group of sold vehicles by selecting vehicles having at least one attribute in common with the target vehicle and, analyzing the sale price of at least one vehicle of the group of sold vehicles with respect to the advertised price of the target vehicle, where generating the report includes quantitatively assessing the relative value of the target vehicle with respect to the at least one vehicle of the group of sold vehicles.

It is a fourth aspect of the present invention to provide a method of generating a vehicle value report, the method comprising: (a) receiving a request for information .related to a particular vehicle; (b) generating a graphical representation using vehicle data attributable to the particular vehicle, the graphical representation depicting at least part of a price spectrum that includes an advertised price of the particular vehicle and a comparable vehicle price; and, (c) generating a report using the vehicle data attributable to the particular vehicle, the report including the graphical representation and at least a portion of the vehicle data.

In a more detailed embodiment of the fourth aspect, the embodiment further includes associating a compilation video with the report, the compilation video comprising at least two video snippets, each video snippet being associated with a specific one of the vehicle data attributable to the vehicle. In yet another more detailed embodiment, the comparable vehicle price includes at least one of an individual advertised price of a comparable vehicle and an average of advertised prices of a group of comparable vehicles. In a further detailed embodiment, the embodiment further includes compiling a comparative data set attributable to a group of vehicles offered for sale by selecting vehicles having at least one attribute in common with a target vehicle and, analyzing an advertised price of at least one vehicle of the group of vehicles for sale with respect to the advertised price of the target vehicle, where generating the report includes quantitatively assessing the relative value of the target vehicle with respect to the at least one vehicle of the group of vehicles offered for sale. In still a further detailed embodiment, the embodiment further includes compiling a comparative data set attributable to a group of sold vehicles by selecting vehicles having at least one attribute in common with a target vehicle and, analyzing a sale price of at least one vehicle of the group of sold vehicles with respect to the advertised price of the target vehicle, where generating the report includes quantitatively assessing the relative value of the target vehicle with respect to the at least one vehicle of the group of sold vehicles.

### BRIEF DESCRIPTION OF THE DRAWINGS

FIG. 1 is a schematic diagram depicting an exemplary computer environment for use with the exemplary embodiments.

FIG. 2 is a first page of an exemplary value report in accordance with the instant disclosure.

FIG. 3 is a second page of an exemplary value report in accordance with the instant disclosure.

FIG. 4 is a third page of an exemplary value report in accordance with the instant disclosure.

FIG. 5 is a fourth page of an exemplary value report in accordance with the instant disclosure.

FIG. 6 is a fifth page of an exemplary value report in accordance with the instant disclosure.

FIG. 7 is a screen shot of a webpage through which a consumer or other party can access a value report for a particular vehicle.

### DETAILED DESCRIPTION

The exemplary embodiments of the present invention arc described and illustrated below to encompass methods, systems, and devices related to analyzing a value of a vehicle and methods, systems, and devices related to generating one or more reports comprising vehicle data and comparison data related to pricing information of a particular vehicle in relation to similar vehicles within a geographic region. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

To provide additional context for various aspects of the exemplary embodiments disclosed herein, the following is a description of a suitable computing environment 100 in which the various aspects of the exemplary embodiments may be implemented. While the exemplary embodiments disclosed herein relate to computer-executable instructions that may run on one or more computers, those skilled in the art will recognize that the exemplary embodiments may be implemented in combination with other program modules or as a combination of hardware and software.

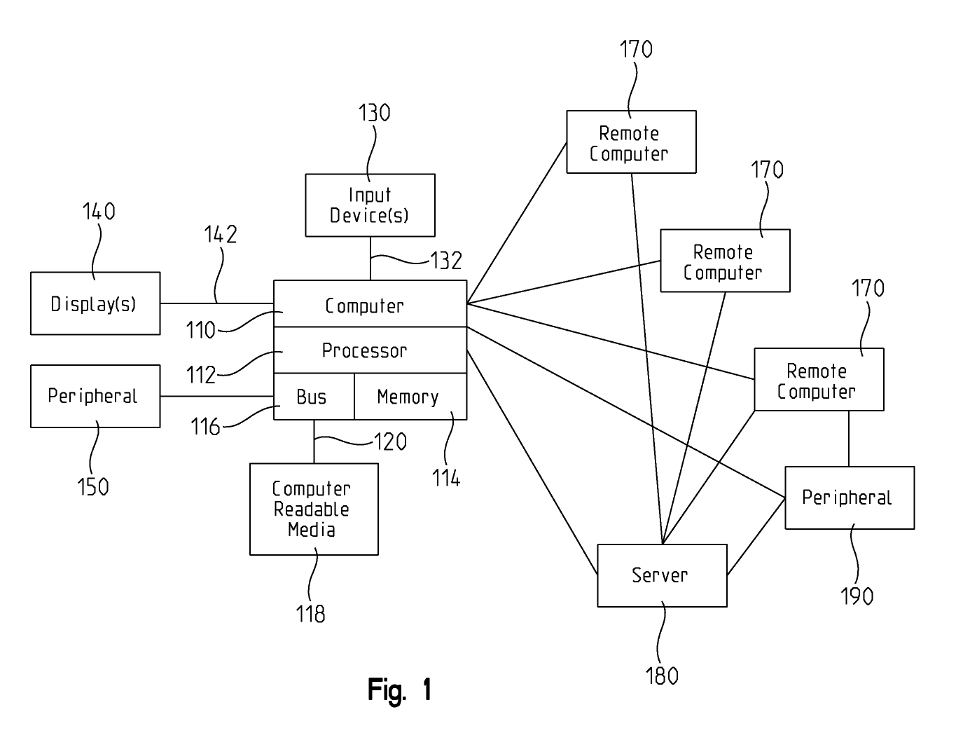

Referring to FIG. 1, an exemplary computing environment 100 for implementing various aspects of the invention may include a computer 110 that includes a processor 112, system memory 114, and a system bus 116. The system bus 116 couples system components to one another including, without limitation, the system memory 114 to the processor 112. The processor 112 may be any of various processors including those that are commercially available. Moreover, dual microprocessors and other multi processor architectures may be employed as the processor 112.

The system bus 116 may be any of several types of bus structure that may further interconnect to a memory bus (with or without a memory controller), a peripheral bus, and a local bus using any of a variety of bus architectures including those commercially available. The system memory 114 may include read only memory (ROM) and/or random access memory (RAM). A basic input/output system (BIOS) may be stored in a non-volatile memory such as ROM, EPROM, EEPROM, which BIOS contains the basic routines that help to transfer information between components within the computer 110, such as during start-up. The RAM may also include a high-speed RAM such as static RAM for caching data.

The computer 110 may further include computer readable storage devices 118. Computer readable storage devices 118 may be any available media that can be accessed by the computer and includes both volatile and nonvolatile media, removable and non-removable media. Computer readable storage devices 118 include generally any method or technology for storage of information such as computer readable instructions, data structures, program modules or other data. Computer readable storage devices 118 include, without limitation, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer 110, such as zip drives and flash memory cards.

In exemplary form, the computer 110 includes an internal/external hard disk drive (HDD) (e.g., EIDE, SATA), a magnetic floppy disk drive (FDD), (e.g., to read from or write to a removable diskette), and an optical disk drive (e.g., reading a CD-ROM disk or, to read from or write to other high capacity optical media such as the DVD). The multiple computer storage devices 118 (hard disk drive, magnetic disk drive and optical disk drive) may be connected to the system bus 116 by an interface 120 (e.g., hard disk drive interface, a magnetic disk drive interface and an optical drive interface, respectively). The interface 120 for external drive implementations may include at least one or both of Universal Serial Bus (USB) and IEEE 1394 interface technologies.

The readable computer storage device 118 may store a number of program modules in the drives and RAM, including an operating system, one or more application programs, other program modules and program data. All or portions of the operating system, applications, modules, and/or data may also be cached in the RAM. It is appreciated that the exemplary embodiments may be implemented with various commercially available operating systems or combinations of operating systems.

Generally, program modules include routines, programs, components, data structures, etc., that perform particular tasks or implement particular abstract data types. Moreover, those skilled in the art will appreciate that aspects of the exemplary embodiments may be practiced with other computer system configurations including, without limitation, single-processor or multiprocessor computer systems, minicomputers, mainframe computers, as well as personal computers, hand-held wireless computing devices, microprocessor-based or programmable consumer electronics, each of which can be operatively coupled to one or more associated devices. Aspects of the exemplary embodiments may also be practiced in distributed computing environments where certain tasks are performed by remote processing devices that are linked through a communications network. In a distributed computing environment, program modules may be located in both local and remote memory storage devices.

It is within the scope of the disclosure that a user may enter commands and information with respect to the computer 110 through one or more wired/wireless input devices 130. Exemplary input devices 130 include, without limitation, a keyboard and/or a pointing device, such as a mouse. Other input devices 130 may include a microphone (functioning in association with appropriate language processing/recognition software as know to those of ordinary skill in the technology), an IR remote control, a joystick, a game pad, a stylus pen, or the like. These foregoing input devices 130 are often connected to the processor 112 through an input device interface 132 that is coupled to the system bus 116, but may be connected by other interfaces (not shown) including a parallel port, an IEEE 1394 serial port, a game port, a USB port, an IR interface, etc.

A display 140 for the computer 110 may also be connected to the system bus 116 via an interface 142, such as a video adapter. In exemplary form, the display 140 may comprise a touch screen that is operative to send inputs to the computer 110 akin to an input device 130.

The computer 110 may further include one or more peripheral output devices 150 such as, without limitation, a speaker and a printer that arc communicatively coupled thereto. This communication may occur wirelessly or through a wired connection.

The computer 110 may operate in a networked environment and be communicatively coupled to one or more remote computers 170. The remote computer(s) 170 may be a workstation, a server computer 180, a router, a personal computer, a portable computer, a personal digital assistant, a cellular device, a microprocessor-based entertainment appliance, a peer device or other common network node, and may include many or all of the elements described relative to the computer. The communication connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer 110 may be operable to communicate with any peripheral device 190 or entities operatively disposed in wired or wireless communication such as, without limitation, a printer, scanner, desktop/portable computer, portable data assistant, smart phone, communications satellite, and any piece of equipment or location associated with a wirelessly detectable tag (e.g., a kiosk, news stand, restroom). This wireless communication includes at least Wi-Fi (such as IEEE 802.11x (a, b, g, n, etc.)) and Bluetooth™ wireless technologies. Accordingly, the communication from/to the computer 110 and the remote computers 170 and/or peripheral device 190 may be via a predefined communication network or simply an ad hoc communication between at least two devices.

The computing environment 100 may also include a server 180 as one of the remote computers 170. The server 180 may also include hardware and/or software (e.g., threads, processes, computing devices) and house threads to perform transformations by employing aspects of the exemplary embodiments, for example. One possible communication between the computer 110 and the server 180 includes a data packet transmitted among the computers. The data packet may include a cookie and/or associated contextual information, for example. The computer 110 and/or remote computer(s) 170 (specifically, the server 180) may be operatively coupled to a communication framework (e.g., a global communication network such as the Internet) in order to facilitate communications among computers.

In this exemplary computing environment 100, the server 180 may receive data from several sources concerning a particular vehicle and transmit this data to the computer 110. These sources include vehicle dealer information as well as information from independent third party sources (e.g., CarFax, AutoCheck). In exemplary form, each source makes available a raw file or a data file that is keyed to a particular data field or identifier. In one exemplary circumstance, the raw file or data file is principally identified using the VIN. This VIN and the associated data in the file is downloaded or saved using the memory 114 and/or the computer readable media 118.

By way of example, raw files or data files coming from a particular source generally have the same format or data order. In this manner, the computer 110 includes a data importer program to recognize the source, as well as to recognize the data and extract the data from the file and associate this data into one or more particular fields (e.g., price, mileage, make, model, year, color, etc.). For example, the raw file may include a data string having price and mileage information. The computer is programmed to recognize the location or format of data within the string or file in order to extract or associate the price data with the price value and associate the mileage with the mileage value in order to construct a value report. It should be understood that there is not necessarily a limit on the third party sources that may send vehicle information to the server 180, thereby allowing new third party sources to be readily added.

The computer 110 may also be programmed to make inquiries with one or more sources to ensure the vehicle data is up-to-date. In exemplary form, the computer 110 makes-a request of each source to retransmit the raw file or a data file on a predetermined basis such as, without limitation, once every minute, once every hour, once every day, once every week, and once a month. Alternatively or in addition, the computer 110 may simply make a request of each source to provide only information for a particular vehicle that has changed within a predetermined period of time.

The vehicle data from the sources (i.e., dealerships and the third party sources) is processed and/or standardized by the computer 110 in order to provide information in a form or format that is relatively the same to the consumer no matter what vehicle is chosen. In exemplary form, the vehicle data may be processed and/or standardized using a predetermined set of rules in order to generate a value report 200, as described in more detail hereafter.

As part of the value report 200, the particular vehicle data is analyzed to pair down other comparative vehicles for sale based upon whether these other vehicles are “similar” using any number of attributes (e.g., year, make, model, similar trim, similar mileage range, similar status (new, used and/or certified)). Part of the comparison may include accounting for the location of the similar vehicles and thereafter generating the value report 200 and possibly using the server to make the report accessible. Value reports 200 may display which attributes the comparable vehicles do or do not have based on what the specific vehicle within the value report does have. This may allow a consumer and/or subscriber to view a value report on a specific vehicle and quickly determine what attributes the other comparable vehicles are missing. Further, this may allow a consumer and/or subscriber to view a value report on a specific vehicle and quickly determine what attributes the other comparable vehicles do have to quickly see the “value” in each of those vehicles.

Referring to FIGS. 1-6, a first exemplary embodiment provides the value report 200 generated by the computer 110 after processing and/or standardizing data from one or more sources (e.g., dealers and independent third party sources). Each source may provide one or more of vehicle information, safety information, and value related information. The information is processed by the computer 110 based on one or more rules and presents the processed data (i.e., results) as part of the value report 200. Some of the processed data is utilized by the computer 110 to generate a graphical display 210 depicting the price of a particular vehicle in comparison to other similar or comparable vehicles publicly offered for sale.

For example, a consumer may be interested in purchasing a 2007 Honda Accord. And two local car dealers have two cars that fit the consumer's initial criteria. But before the consumer makes an offer to purchase a 2007 Honda Accord, the consumer goes to purecars.com to see whether the local car dealers' prices are reasonable and learn more about the condition of both vehicles, in addition to information about other 2007 Honda Accord.

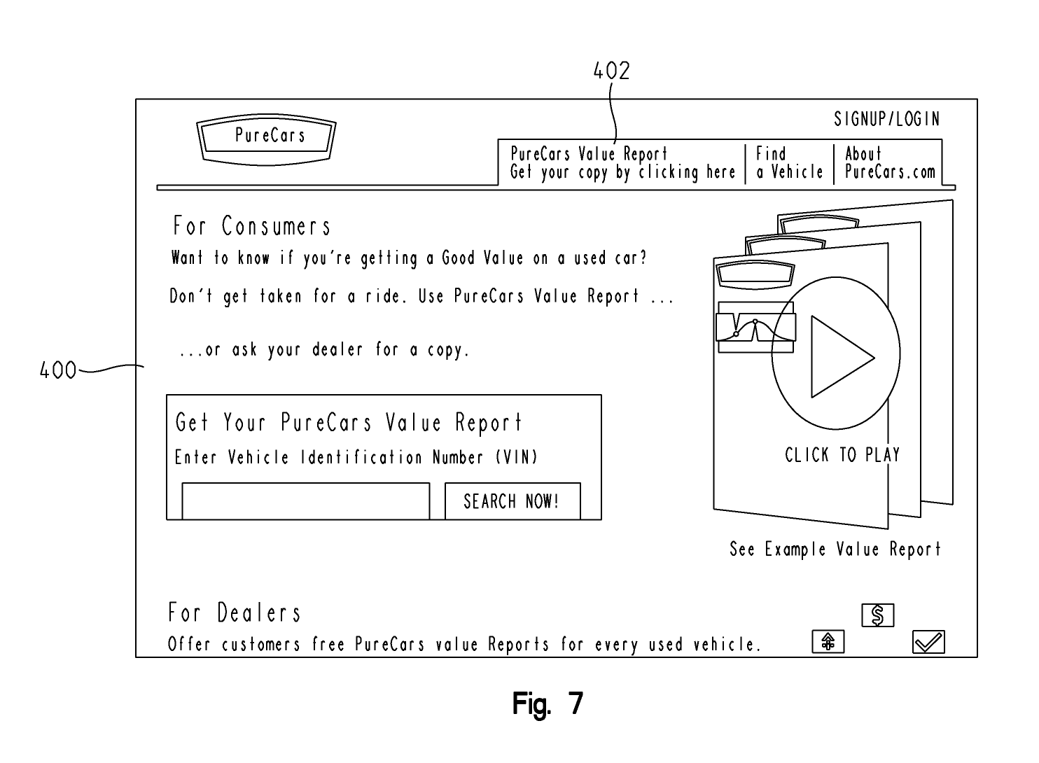

Referring to FIG. 7, the consumer accesses the Internet and goes to the purecars.com homepage 400. When at the homepage, the consumer may choose to access a value report 200 directly by selecting the PureCars Value Report tab 402 and thereafter entering the vehicle identification number (VIN). Alternatively, the consumer may choose to search for 2007 Honda Accords based upon various criteria. In this first exemplary embodiment, the consumer already has the VIN and wants to see the value report for a particular car. As a result, the consumer clicks on the PureCars Value Report tab 402, which takes the consumer to a second webpage where the consumer enters the VIN.

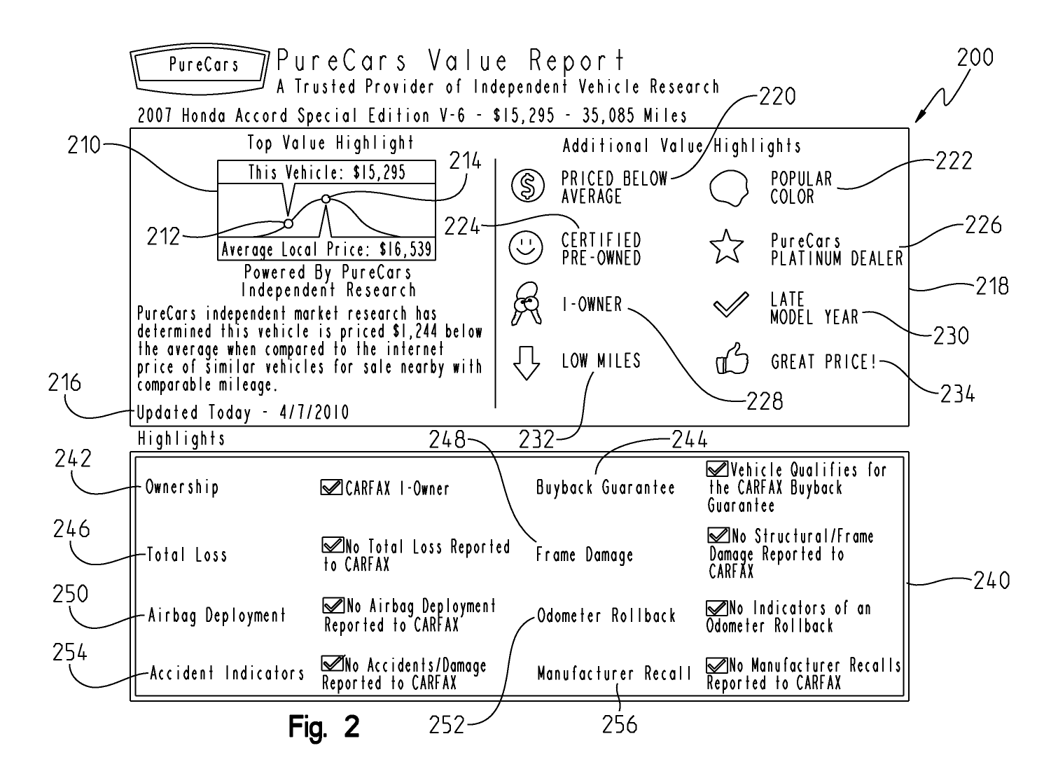

Referencing FIG. 2, entry of the VIN sends a signal to the computer 110 to access the stored data specific to that particular vehicle, as well as generate variable data that is time dependent. In this exemplary embodiment, value report 200 may be accessed via the Internet such as at purecars.com, for example, or at a subscriber's website. A subscriber may provide a direct link to a purecars.com web page showing specific information regarding the subscriber's inventory or a specific vehicle.

Specific vehicle data and variable data may be both utilized to generate the value report 200 that may include a graphical display 210 in the form of a bell curve or price-specific curve depicting the price 212 of this particular vehicle with respect to an average offered price 214 for other similar or comparable vehicles publicly offered for sale. The graphical display 210 may include an embedded link that is actuated by the user (e.g., a consumer) clicking on the graphical display. For example, a consumer may search for a used vehicle and then click the pricing graph to view the value report for that specific vehicle. This may be accomplished by a uniform resource locator (URL) which may contain the vehicle identification number (VIN) to a vehicle that a consumer is viewing. In exemplary form, the dealer's website provider may send purecars.com a command (e.g., $VIN$) to pull the VIN into the URL. Alternatively, purecars.com may read the code on the dealer webpage to extract the VIN.

The display or graph 210 of the value report 200 provides a consumer with a real-time (or substantially real-time) comparison of how a vehicle is priced versus similar vehicles within a predetermined or user-selected criteria, such as “x” miles away from a location (e.g., a home address). Similar vehicles may have similar attributes and/or features. In exemplary form, the extent of the similarity is based, in part, upon the algorithms utilized to gather data on “similar” vehicles and may be based upon user input. The graphical display 210 also includes a calendar date 216 in order to provide a time stamp to the consumer concerning this value data.

Also included as part of the value report 200 may be an additional value section 218 having one or more graphics representative of key data. Each graphic is tied to more specific data that is displayed in the form of a pop-up window to the consumer when a cursor of the consumer is over the graphic. By way of example, this exemplary value report 200 includes eight graphics. The first graphic 220, “priced below average,” is tied to a pop-up window that tells the consumer that the price of this 2007 Honda Accord is priced below the average selling price of $16,539 by $1,244. The second graphic 222, “popular color,” tells the consumer that the color of this vehicle is considered to be in relatively high demand taking into account the number of other vehicles having this same or similar color, in addition to sales data indicating how frequently vehicles of this color are purchased. The third graphic 224, “certified pre-owned,” indicates to the consumer that this vehicle has been certified by a dealer and includes a warranty. The fourth graphic 226, “PureCars platinum dealer,” conveys to the consumer that this dealer is committed to openly display the value report 200 on all of their pre-owned vehicles to assure the consumer has the information helpful to make an informed decision. The fifth graphic 228, “CarFax 1-owner,” tells the consumer that based upon the information compiled by CarFax, this vehicle appears to have had only one prior owner. The sixth graphic 230, “late model year,” conveys to the consumer that this vehicle is five years old or less. The seventh graphic 232, “low miles,” indicates to the consumer that this vehicle has low mileage relative to its age and that low mileage vehicles may be more valuable than similar vehicles with higher mileage. The eighth graphic 234, “great price,” tells the consumer that the compiled and processed data reflects that this vehicle to be priced well below the local average when compared to similar vehicles with like mileage.

Alternatively or in addition, the additional value section 218 may include a custom video or other graphics to promote the value indicators of each vehicle while informing the consumer on the benefits of each of those indicators. For example, video clips or snippets may be linked to one or more of the graphics 220-234 to help consumers understand the value a vehicle of interest may have. Each video clip or snippet may be coupled or “stitched” together essentially on demand in a format that flows together. These video clips or snippets (audio, video, photos, etc.) may be stored on a storage device accessible to the computer in order to the computer to access this information when consumer demand occurs.

By way of example, when the consumer positions his/her icon over one of the graphics 220-234, a video clip or snippet is displayed to the consumer. More specifically, when the consumer positions his/her cursor over the first graphic 220, a video clip or snippet is displayed with associated audio stating, “PureCars has independently verified this vehicle is priced below the average when compared to the pricing of similar vehicles nearest you.” When the consumer positions his/her cursor over the second graphic 222, a video clip or snippet is displayed with associated audio stating, “PureCars has independently verified this vehicle has an exterior color that is popular based upon independent data.” When the consumer positions his/her cursor over the third graphic 224, a video clip or snippet is displayed with associated audio stating, “PureCars has verified this vehicle has been certified by the dealer, assuring you of its quality.” When the consumer positions his/her cursor over the fourth graphic 226, a video clip or snippet is displayed with associated audio stating, “PureCars Platinum Dealers promise to provide their customers with top quality service, the highest level of satisfaction, and a commitment to building trusting relationships through honest business practices.” When the consumer positions his/her cursor over the fifth graphic 228, a video clip or snippet is displayed with associated audio stating, “CarFax finds this to be a one owner vehicle. The following is the CarFax.” When the consumer positions his/her cursor over the sixth graphic 230, a video clip or snippet is displayed with associated audio stating, “PureCars has verified that this vehicle is less than five years old.” When the consumer positions his/her cursor over the seventh graphic 232, a video clip or snippet is displayed with associated audio stating, “PureCars has verified this vehicle has been driven under 10,000 miles per model year, and doesn't have more than 40,000 miles.” When the consumer positions his/her cursor over the eighth graphic 234, a video clip or snippet is displayed with associated audio stating, “PureCars has independently verified this vehicle is a Great Price when compared to the pricing of similar vehicles nearest you.”

An exemplary value report 200 may also include a compiled video related to attributes of a specific vehicle. An exemplary video may sound as if it is a contiguous full script, but each attribute may indeed have a video snippet associated therewith. Each attribute may be recorded separate and “stitched together” electronically. This allows a custom video for each vehicle. Additionally, it provides the ability to quickly add new variables or modify scripts without rerecording hundreds of options. By way of example, the exemplary compiled video may combine one or more of the following video components. (A) For a new vehicle: “Hi I'm with PureCars, an independent research company. We provide you with local competitive pricing information, to help you determine the value of pre-owned vehicles. You're currently viewing a new vehicle, which may have various options, incentives, rebates, or other dealer promotions available. As such, we're unable to offer you our independent PURE Pricing Report. We recommend contacting the dealer by clicking here to learn more about this vehicle and any current specials that may apply. Be sure to look for me on any pre-owned vehicles this dealer offers, and I'll be happy to provide you a comprehensive PURE Pricing Report which includes current local competitive pricing information to help you make a smart buying decision.” (B) For a used vehicle with no VIN number available: “Hi I'm with PureCars, an independent research company. I'm here to educate you on how this vehicle is priced compared to other ones like it. This vehicle recently arrived at the dealer, as we have not yet completed our independent PURE Pricing Report. Please click here to contact this PURE Certified Dealer and request more information on the vehicle. PURE Certified Dealers promises to provide you with the information you need to make a smart buying decision.” (C) For a vehicle priced below average: “Hi I'm with PureCars, an independent research company. I'm here to educate you on how this vehicle is priced compared to other ones like it. You can shop with confidence knowing our independent research has found this vehicle to be one of the most competitively priced in your area. See for yourself by clicking on the graph to view our exclusive PURE Pricing Report, which includes competitive pricing information.” (D) For a vehicle priced about average: “Hi I'm with PureCars, an independent research company. I'm here to educate you on how this vehicle is priced compared to other ones like it. You'll be glad to learn our independent research has verified this vehicle is priced competitively in your area. See for yourself by clicking on the graph to view our exclusive PURE Pricing Report, which includes competitive pricing information.” (E) For a vehicle priced above average: “Hi I'm with PureCars, an independent research company. I'm here to educate you on how this vehicle is priced compared to other ones like it. The value offered by each pre-owned vehicle can vary. A vehicle may be in excellent condition, or offer special features that increase its value. Be sure to contact this PURE Certified Dealer by clicking here to learn more about what makes it unique.” (F) For a vehicle that is certified: “This vehicle appears to have been certified by the dealer, assuring you of its quality. Certified vehicles typically go through a detailed inspection and may offer benefits such as a warranty. They are usually in better condition than non-certified vehicles, which provides additional value. If interested, click here to learn more about the certification process.” (G) For a vehicle having a CarFax report available: “Also know there is a CarFax Vehicle History Report available on this vehicle. Be sure to click over here to view it.” (H) For a vehicle that is a CarFax one owner: “Also know CarFax estimates this vehicle has had one previous owner. One owner vehicles are typically in higher demand. To learn more click here to view a free CarFax Vehicle History Report.” (I) For a vehicle having a CarFax report indicating no prior accidents: “By clicking on the CarFax logo you'll also discover this vehicle has not had any accidents reported to CarFax. Accident free vehicle vehicles are more desirable than vehicles which haven't been so lucky.” An exemplary video snippet script may also include closing comments such as: “Each pre-owned vehicle is different, and that's why PureCars is dedicated to providing you with the most comprehensive information to help you make a smart buying decision. If you would like to learn more about this vehicle, please click here to contact the dealer directly.”

Further included as part of the value report 200 may be a highlights section 240 providing textual summaries of considerations a consumer may consider dispositive when purchasing or evaluating the value of a vehicle. In exemplary form, a first highlight 242 indicates that a CarFax report for the vehicle in question indicates the vehicle has only one prior owner. The second highlight 244 indicates this vehicle qualifies to be purchased by CarFax (up to 10% over the Kelley Blue Book value) if the CarFax report states that the vehicle has a title history with no Branded Titles showing, but a Branded Title actually exists (Branded Titles mean titles originally issued without a Brand but later stamped with a Brand without being reissued; salvage titles issued due to theft; damage disclosure documents and Branded Titles issued in error and later corrected). The third highlight 246 indicates this vehicle has not been reported as having a claim that exceeds approximately 75% of the vehicle's pre-damage value or if the vehicle was stolen and not recovered. The fourth highlight 248 indicates this vehicle, according to CarFax, has not been in a collision that resulted in frame damage. The fifth highlight 250 indicates CarFax is unaware of any airbag deployment occurring in this vehicle. The sixth highlight 252 indicates the absence of any data associated with the vehicle evidencing tampering with the odometer. The seventh highlight 254 indicates that this vehicle has not been reported as having been in an accident or received other significant damage. The eighth highlight 256 indicates this vehicle is not subject to one or more manufacturer recalls.

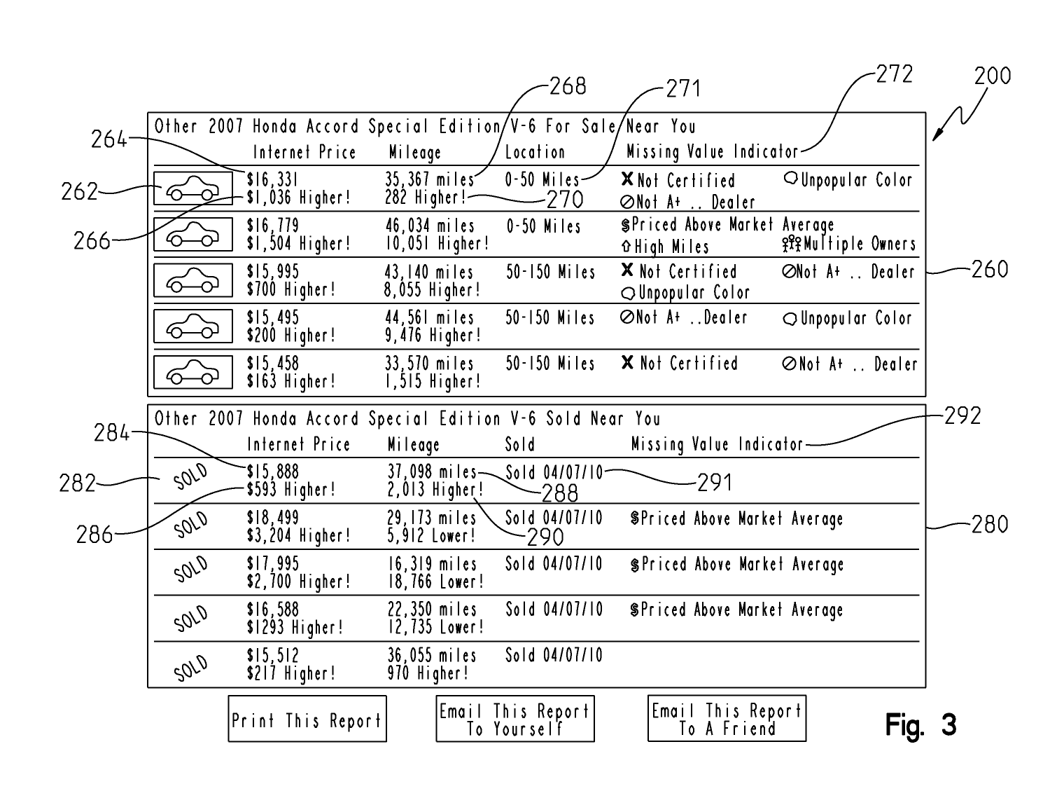

Referencing FIG. 3, the value report 200 may also include a for sale comparative vehicle section 260. This section 260 includes a listing of particular vehicles for sale that meet the consumer's initial qualifiers such, without limitation, price range, mileage, location, model year, manufacturer, model, trim package, vehicle age, and vehicle color. The for sale comparative vehicle section 260 includes a listing of comparative vehicles for sale as well as additional information about the vehicles so the consumer can better gauge what the marketplace is doing and whether the particular vehicle the consumer is looking avis a better, relatively the same, or worse value than other vehicles also offered for sale. In exemplary form, the section 260 includes a picture 262 of each comparative actual vehicle for sale (or a representative default photo), the advertised price 264 of the comparative vehicle, the amount difference 266 between the advertised price and the price of the vehicle the consumer is primarily interested in, the mileage 268 and the difference 270 in mileage between the comparative vehicle and the vehicle the consumer is primarily interested in, the distance 271 how far away the comparative vehicle is from the consumer, and a listing 272 of value indicators that are missing from the comparative vehicle (such as certification, popular color, 1-owner, low mileage, platinum dealer). In this manner, the for sale comparative vehicle section 260 compiles in a single location visual representations of each comparative vehicle, relevant price considerations, relevant mileage information, relevant location information, and primary value considerations missing. This information provides an immediate comparison and better allows the consumer to evaluate whether the vehicle the consumer is primarily interested in is in fact a good value for the advertised price.

The value report 200 may further include a sold comparative vehicle section 280. This section 280 includes a listing of particular vehicles recently sold that would have met the consumer's initial qualifiers such, without limitation, price range, mileage, location, model year, manufacturer, model, trim package, vehicle age, and vehicle color. The sold comparative vehicle section 280 includes a listing of comparative vehicles sold as well as additional information about the vehicles so the consumer can better gauge what the marketplace is doing and whether the particular vehicle the consumer is looking at is a better, relatively the same, or worse value than other comparable vehicles recently sold. In exemplary form, the section 280 includes a picture 282 of each comparative actual vehicle sold (or a representative default photograph), the advertised price 284 of the comparative vehicle, the amount difference 286 between the advertised price and the price of the vehicle the consumer is primarily interested in, the mileage 288 and the difference 290 in mileage between the comparative vehicle and the vehicle the consumer is primarily interested in, the calendar date the comparative vehicle was sold 291, and a listing 292 of value indicators that are missing from the comparative vehicle (such as certification, popular color, 1-owner, low mileage, platinum dealer). In this manner, the sold comparative vehicle section 280 compiles in a single location visual representations of each sold comparative vehicle, relevant price considerations, relevant mileage information, relevant location information, and primary value considerations missing. This information provides an immediate comparison and better allows the consumer to evaluate whether the vehicle the consumer is primarily interested in is in fact a good value for the advertised price.

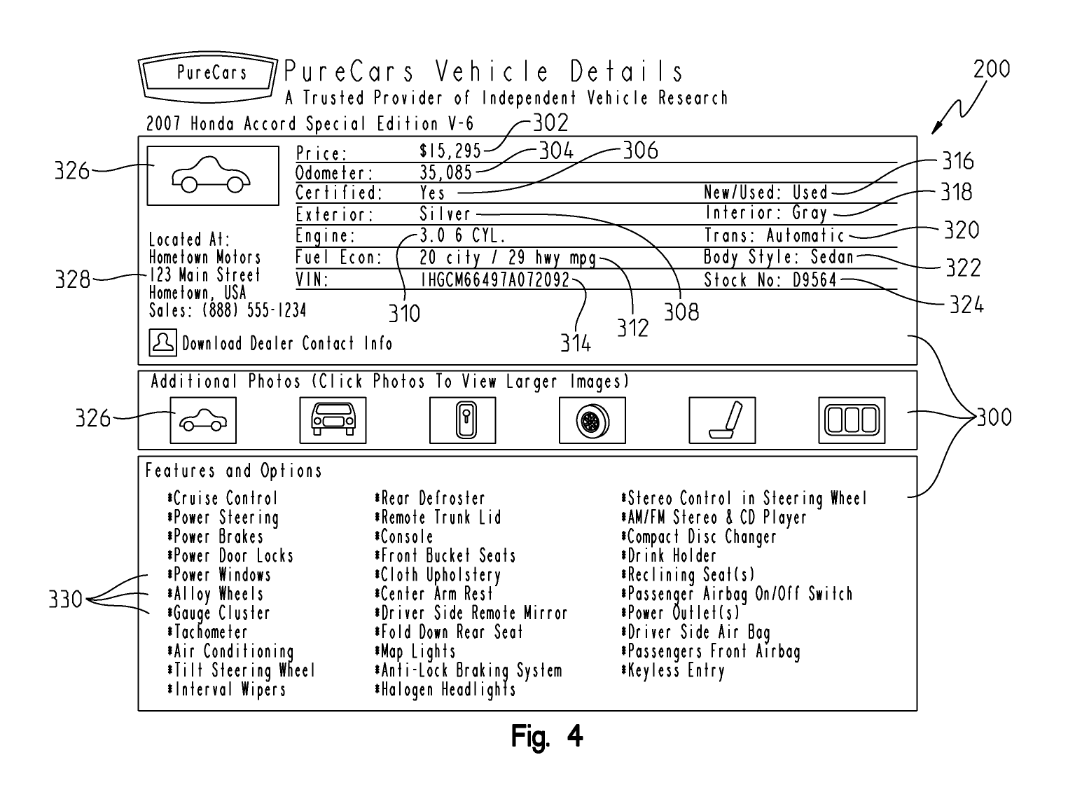

Referring to FIG. 4, the value report 200 may also include a detailed listing of vehicle attributes compiled in a single section or multiple sections 300. This section 300 includes a number of standardized pieces of information about a particular vehicle such as, without limitation, price 302, odometer reading 304, certification 306, exterior color 308, engine size 310, estimated fuel economy 312, VIN 314, new/used status 316, interior color 318, transmission type 320, body style 322, and dealer stock number 324. In addition to this standardized information, the section may also include one or more picture 326 of the vehicle in question (or representative photograph) as well as dealer information 328 (including, e.g., dealer name, address, and telephone number). These pictures 326 may be of the exterior and/or the interior of the vehicle in question. In addition to the foregoing information, the attributes section 300 may include a series of bullet points 330 that list features and options specific to the vehicle in question including, without limitation, cruise control, power steering, power brakes, power door locks, power windows, alloy wheels, gauge cluster, tachometer, air conditioning, tilt steering wheel, interval wipers, rear defroster, remote trunk lid, console, bucket seats, cloth or leather interior; remote mirrors, fold down seats; anti-lock breaks, halogen headlights, AM/FM/CD stereo, passenger airbag switch, power outlets and, keyless entry.

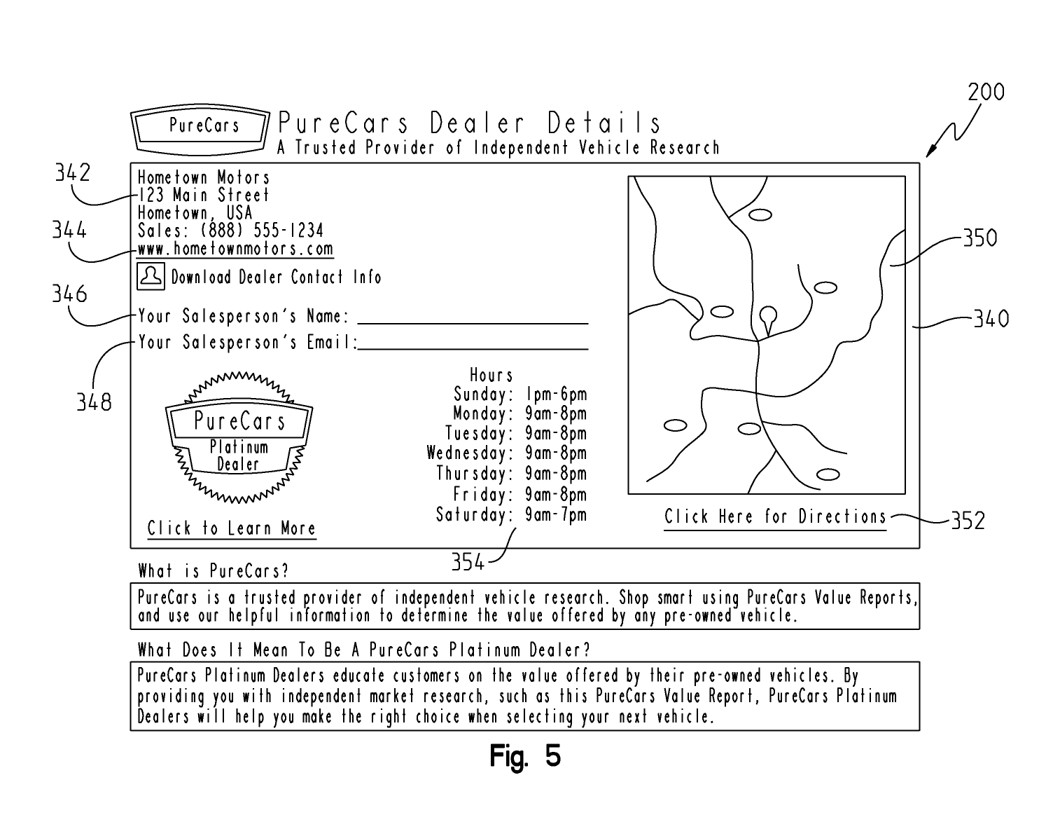

Referencing FIG. 5, the value report 200 may also include a dealer summary 340. In exemplary form, the dealer summary 340 may include address and telephone contact information 342 for the dealer selling the particular vehicle the consumer is interested in. In addition, presuming the dealer has a website, the dealer's website may be listed along with a link 344 directly to the dealer's general website page or the specific vehicle webpage. If the dealer provides more specific contact information, such as a salesperson name 346 and salesperson email address 348, this information may be provided as well. Adjacent to the dealer contact information 342 is a map 350 and an associated webpage link 352 providing location and directional information to the consumer regarding the location of the dealer selling the vehicle. In addition to dealer contact information 342, the dealer summary 340 may also include a summary 354 of the hours of operation of the dealer.

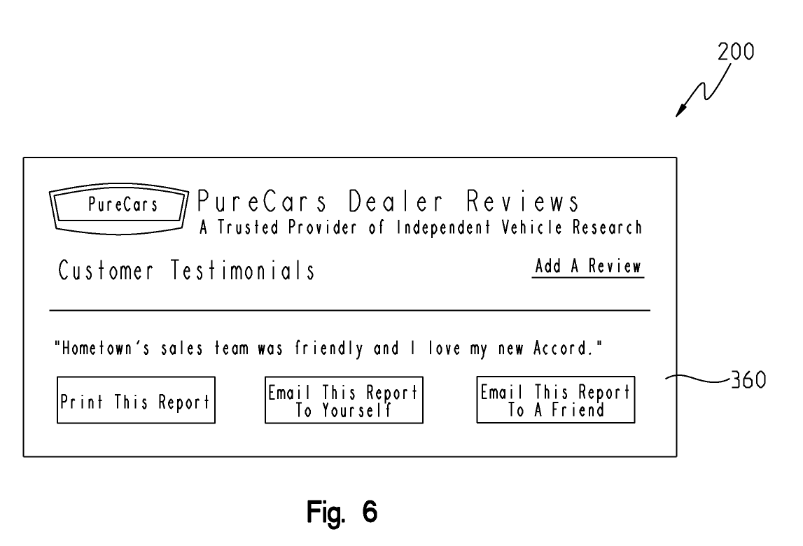

Referring to FIG. 6, the value report 200 may also include a testimonial section 360. In exemplary form, the testimonial section 360 may include actual testimonials about a dealer from consumers having previously purchased a vehicle from a particular dealer. In addition, the testimonial section 360 may include actual testimonials about the PureCars experience from consumers that have used the experience to purchase a vehicle.

While the foregoing exemplary embodiment has been explained with respect to a potential consumer accessing the website of a service provider (e.g., PureCars), it is also within the scope of the disclosure for the value report 200 to be generated and/or displayed dynamically on a subscriber's (e.g., a dealer) website. In exemplary form, a value report 200 may be provided to subscribers of a value reporting service. Subscribers may include vehicle dealers and/or dealerships, for example. Pricing information may be provided in a competitive format to educate subscribers on how their inventory is priced. The subscriber may then be given the option to access a report for all vehicles in the subscriber's inventory that includes a comparison and/or pricing analysis of how the dealer's inventory is priced compared to the dealer's competition.

It is also within the scope of the instant disclosure to provide a consumer with a printed copy or electronic copy of the value report 200. The printed copy may be made availableto the customer by regular mail or at a dealer showroom. Alternatively, or in addition, the electronic copy of the value report 200 may be electronically transmitted to the customer such as in the form of an email or email attachment.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method of analyzing a value of a vehicle, the method comprising:
receiving a request for information concerning a particular vehicle for sale;
receiving vehicle data concerning the particular vehicle and a plurality similar vehicles for sale from at least one source;
comparing the vehicle data to identify a subset comprising a plurality of comparable vehicles that arc comparable to the particular vehicle and that are for sale;
comparing the vehicle data of the particular vehicle to the vehicle data of at least one of the plurality of comparable vehicles to asses a relative value of the particular vehicle; and,
generating a report that conveys the relative value of the particular vehicle.

2. The method of claim 1, wherein receiving vehicle data from at least one source further comprises formatting the vehicle data based utilizing a standardized rule set.

3. The method of claim 1, wherein the vehicle data comprises at least three of a make, a model, a year, a body style, a trim, an interior color, an exterior color, a mileage, a certified status, a used status, a new status, a transmission type, an engine, a fuel economy rating, a warranty, a vehicle identification number, a stock identifier, a dealer, a location, and a price.

4. The method of claim 1, wherein the vehicle data comprises at least one of a number of accidents reported, a number of previous owners, and an identification of previous owners.

5. The method of claim 1, wherein the request for information comprises at least one of a year, a make, a model, a mileage, a location, and a zip code.

6. The method of claim 1,
wherein generating the report further comprises generating a compilation video by operably coupling at least two video snippets, each video snippet being associated with a specific one of the vehicle data associated with the particular vehicle; and,
wherein generating the report further comprises at least one of linking and attaching the compilation video to the report.

7. The method of claim 1, wherein the predetermined geographical region comprises a specific mile range.

8. A method of analyzing a value of a vehicle, the method comprising:
compiling a comparative data set attributable to a group of vehicles for sale by selecting vehicles having at least one attribute in common with a target vehicle;
analyzing an advertised price of at least one vehicle of the group of vehicles with respect to an advertised price of the target vehicle; and,
generating a report qualitatively assessing a relative value of the target vehicle with respect to the at least one vehicle of the group of vehicles.

9. The method of claim 8, wherein:
the act of compiling the comparative data set includes compiling individual data sets for each of the group of vehicles;
the comparative data set comprises the individual data sets; and,
the attribute includes at lest one of a make, a model, a year, a body style, a trim, an interior color, an exterior color, a mileage, a certified status, a used status, a new status, a transmission type, an engine, a fuel economy rating, a warranty, a vehicle identification number, a stock identifier, a dealer, a location, and a price.

10. The method of claim 9, further comprising the act of calculating a difference in at least one of mileage and advertised price of the at least one vehicle of the group of vehicles and the target vehicle, wherein the act of generating the report includes quantitatively assessing the difference in at least one of mileage and advertised price of the at least one vehicle of the group of vehicles and the target vehicle.

11. The method of claim 9, wherein the act of generating the report qualitatively assessing the relative value of the target vehicle with respect to the at least one vehicle of the group of vehicles includes displaying at least one standardized value indicator.

12. The method of claim 8, further comprising:
compiling a comparative data set attributable to a group of sold vehicles by selecting vehicles having at least one attribute in common with the target vehicle; and
analyzing a sale price of at least one vehicle of the group of sold vehicles with respect to the advertised price of the target vehicle;
wherein generating the report includes qualitatively assessing the relative value of the target vehicle with respect to the at least one vehicle of the group of sold vehicles.

13. A method of analyzing a value of a vehicle, the method comprising:
compiling a comparative data set attributable to a group of vehicles for sale by selecting vehicles having at least one attribute in common with a target vehicle;
analyzing an advertised price of at least one vehicle of the group of vehicles with respect to an advertised price of the target vehicle; and,
generating a report graphically depicting a quantitative comparison between the advertised price of the target vehicle and an average advertised price of the at least one vehicle of the group of vehicles.

14. The method of claim 13, wherein:
the act of compiling the comparative data set includes compiling individual data sets for each of the group of vehicles;
the comparative data set comprises the individual data sets; and,
the attribute includes at least one of a make, a model, a year, a body style, a trim, an interior color, an exterior color, a mileage, a certified status, a used status, a new status, a transmission type, an engine, a fuel economy rating, a warranty, a vehicle identification number, a stock identifier, a dealer, a location, and a price.

15. The method of claim 14, further comprising the act of calculating a difference in at least one of mileage and advertised price of the at least one vehicle of the group of vehicles and the target vehicle, wherein the act of generating the report includes quantitatively assessing the difference in at least one of mileage and advertised price of the at least one vehicle of the group of vehicles and the target vehicle.

16. The method of claim 14, wherein the act of generating the report includes qualitatively assessing a relative value of the target vehicle with respect to the at least one vehicle of the group of vehicles using standardized value indicators taken from the group of advertised price, mileage, age, and location.

17. The method of claim 13, further comprising:
compiling a comparative data set attributable to a group of sold vehicles by selecting vehicles having at. least one attribute in common with the target vehicle; and,
analyzing the sale price of at least one vehicle of the group of sold vehicles with respect to the advertised price of the target vehicle;
wherein generating the report includes quantitatively assessing the relative value of the target vehicle with respect to the at least one vehicle of the group of sold vehicles.

18. A method of generating a vehicle value report, the method comprising:
receiving a request for information related to a particular vehicle;
generating a graphical representation using vehicle data attributable to the particular vehicle, the graphical representation depicting at least part of a price spectrum that includes an advertised price of the particular vehicle and a comparable vehicle price; and,
generating a report using the vehicle data attributable to the particular vehicle, the report including the graphical representation and at least a portion of the vehicle data.

19. The method of claim 18, further comprising:
associating a compilation video with the report, the compilation video comprising at least two video snippets, each video snippet being associated with a specific one of the vehicle data attributable to the vehicle.

20. The method of claim 18, wherein the comparable vehicle price includes at least one of an individual advertised price of a comparable vehicle and an average of advertised prices of a group of comparable vehicles.

21. The method of claim 18, further comprising:
compiling a comparative data set attributable to a group of vehicles offered for sale by selecting vehicles having at least one attribute in common with a target vehicle; and,
analyzing an advertised price of at least one vehicle of the group of vehicles for sale with respect to the advertised price of the target vehicle;
wherein generating the report includes quantitatively assessing the relative value of the target vehicle with respect to the at least one vehicle of the group of vehicles offered for sale. 22, The method of claim 21, further comprising:
compiling a comparative data set attributable to a group of sold vehicles by selecting vehicles having at least one attribute in common with a target vehicle; and,
analyzing a sale price of at least one vehicle of the group of sold vehicles with respect to the advertised price of the target vehicle;
wherein generating the report includes quantitatively assessing the relative value of the target vehicle with respect to the at least one vehicle of the group of sold vehicles.
